(19) United States
(12) Patent Application Publication
(10) Pub. No.: US 2012/0112984 A1
(43) Pub. Date: May 10, 2012

(54) USB CONNECTOR DEVICE FOR AN ANTENNA

(75) Inventor: CHENG-SI WANG, CHANGHUA HSIEN (TW)

(73) Assignee: TRANS ELECTRIC CO., LTD., CHANGHUA HSIEN (TW)

(21) Appl. No.: 12/939,425

(22) Filed: Nov. 4, 2010

(51) Int. Cl. H01Q 1/50

(52) U.S. Cl. 343/906

(57) ABSTRACT

A USB connector device for an antenna has a first cable, a receiver, a second cable and a USB connector. The first cable has an end connected to the receiver. The second cable has two ends respectively connected to the receiver and the USB connector. Because the receiver and the USB connector are combined in a series-connection way, the series-connection design can compact the structure of the USB connector device for an antenna in accordance with the present invention and reduce redundant cables, and it occupies a single one USB slot of the computer only. The USB connector device is very useful and convenient in use.

### BACKGROUND OF THE INVENTION

1. Field of the Invention

The present invention relates to a USB connector device for an antenna, and more particularly to a USB connector device for an antenna to combine a receiver with a USB connector in a series-connection way.

2. Description of Related Art

With reference to FIGS. 4 and 5, a conventional USB connector device 80 has a splitter 81, a USB connector 82, a receiver 83 and multiple cables 84 connected with the splitter 81, the USB connector 82 and the receiver 83. The splitter 81 is connected with an antenna D via one of the cables 84. The USB connector 82 and the receiver 83 are respectively inserted into two USB slots of a computer L. Accordingly, digital television signals received by the antenna D can be transmitted to the computer L via the receiver 83 and the antenna D is fed with electricity by the computer L via the USB connector 82.

However, to combine the USB connector 82 with the receiver 83 in a parallel-connection way is not compact, requires lots of cables 84 and occupies two USB slots of the computer L. Therefore, the conventional USB connector device needs further improvement.

To overcome the shortcomings, the present invention tends to provide a USB connector device for an antenna to obviate the aforementioned problems.

### SUMMARY OF THE INVENTION

The main objective of the invention is to provide a USB connector device for an antenna to combine a receiver with a USB connector in a series-connection way.

A USB connector device for an antenna has a first cable, a receiver, a second cable and a USB connector. The first cable has an end connected to the receiver. The second cable has two ends respectively connected to the receiver and the USB connector. Because the receiver and the USB connector are combined in a series-connection way, the series-connection design can compact the structure of the USB connector device for an antenna in accordance with the present invention and reduce redundant cables, and it occupies a single one USB slot of the computer only. The USB connector device is very useful and convenient in use.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an antenna assembly with a first embodiment of a USB connector device in accordance with the present invention:

FIG. 2 is an operational perspective view of the USB connector device in FIG. 1;

FIG. 3 is a perspective view of an antenna assembly with a second embodiment of the USB connector device in accordance with the present invention;

FIG. 4 is a side view of an antenna assembly with a conventional USB connector device in accordance with the prior art; and

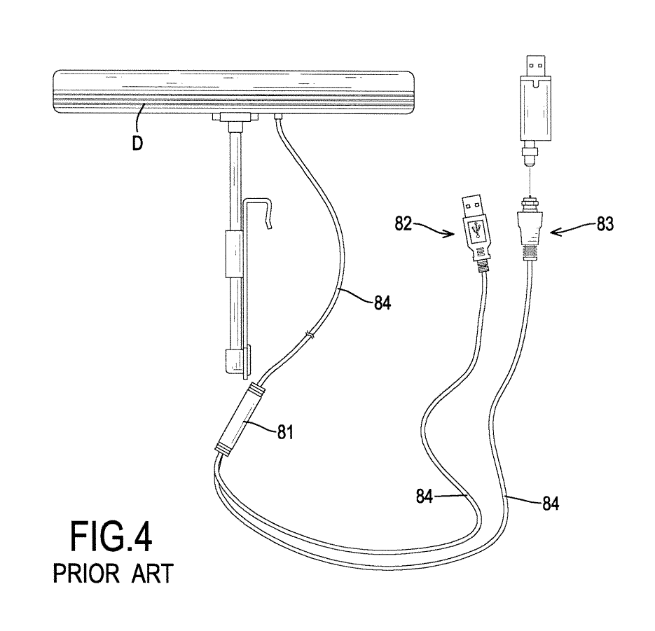

FIG. 5 is an operational perspective view of the conventional USB connector device for an antenna in FIG. 4.

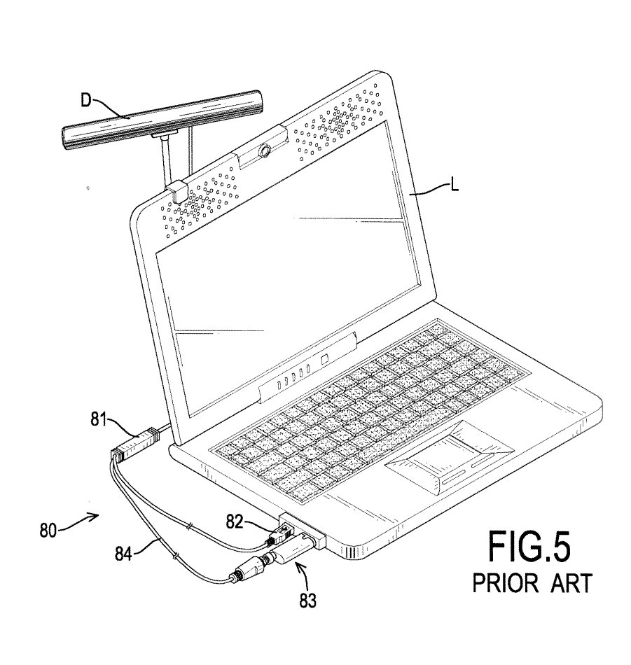

### DETAILED DESCRIPTION OF PREFERRED EMBODIMENT

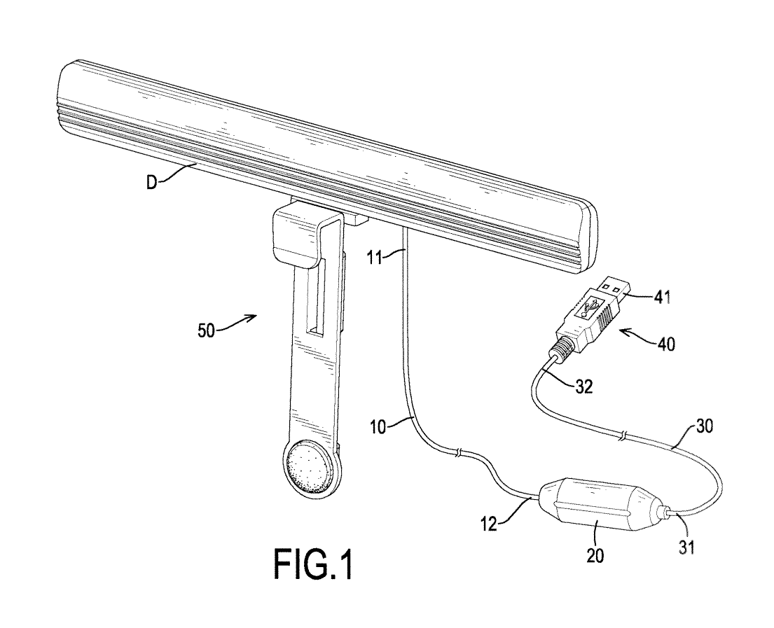

With reference to FIGS. 1 to 3, a first embodiment of a USB connector device for an antenna D in accordance with the present invention comprises a first cable 10, a receiver 20, a second cable 30 and a USB connector 40.

The first cable 10 has an antenna end 11 and a receiver end 12. The antenna end 11 of the first cable 10 is capable of being securely mounted on and electrically connected to the antenna D. The receiver end 12 of the first cable 10 is opposite to the antenna end 11 of the first cable 10.

The receiver 20 may be referred to as a DTV receiver or a Digital TV receiver and is securely mounted on and electrically connected to the receiver end 12 of the first cable 10. The receiver 20 may be conventional and detailed description is omitted.

The second cable 30 has a receiver end 31 and a USB (universal serial bus) end 32. The receiver end 31 of the second cable 30 is securely mounted on and electrically connected to the receiver 20. The USB end 32 of the second cable 30 is opposite to the receiver end 31 of the second cable 30.

The USB (universal serial bus) connector 40 is securely mounted on and electrically connected to the USB end 32 of the second cable 30 and has a plug 41 formed on and protruding out from the USB connector 40 and capable of being inserted into a USB slot of a computer L. Accordingly, digital television signals received by the antenna D can be transmitted to the computer L via the USB connector 40 and the antenna D can be fed with electricity by the computer L via the USB connector 40.

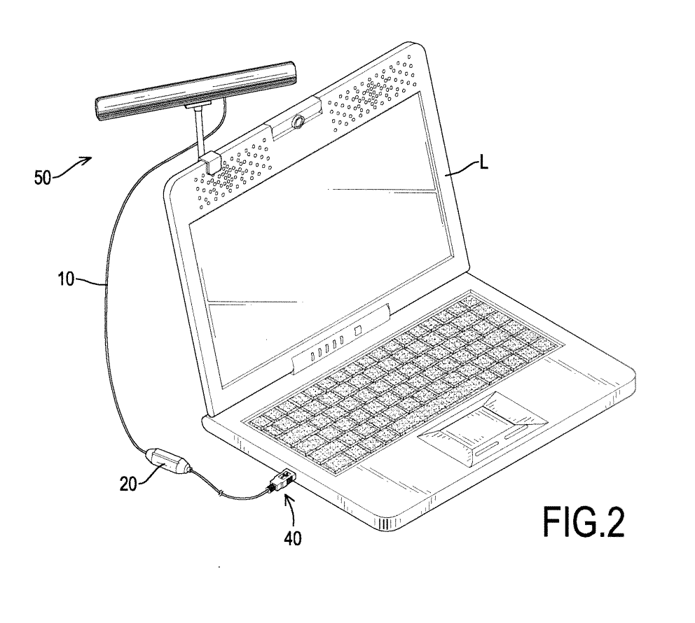

With reference to FIGS. 1 and 2, the first embodiment of the USB connector device in accordance with the present invention is combined with an antenna assembly 50 having the antenna D and an antenna bracket. The structure and instruction of the antenna assembly can be further taught by M383826 of TW patent and is not the subject matter of the present invention. The antenna end 11 of the first cable 10 is securely mounted on and electrically connected to the antenna D; the antenna bracket is detachably connected with the antenna D and is detachably hooked on a top of a monitor of the computer L. The plug 41 is inserted into the USB slot of the computer L. To assemble the USB connector device with the computer L is greatly convenient.

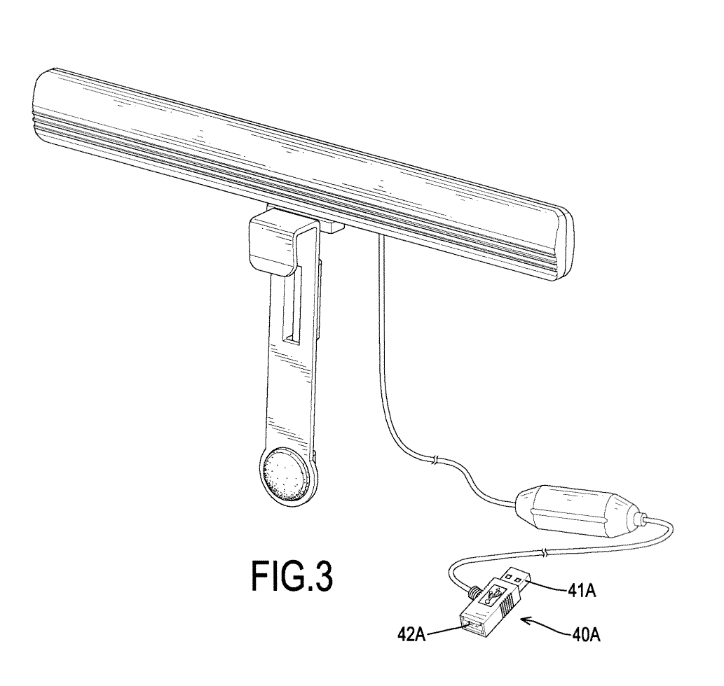

With reference to FIGS. 1 and 3, a second embodiment of the USB connector device for an antenna in accordance with the present invention is substantially the same as the first embodiment except that the USB connector 40A has a receptacle 42A formed in the USB connector 40A and opposite to the plug 41A.

From the above descriptions, it is noted that the present invention has the following advantages: because the receiver 20 and the USB connector 40,40A are combined in a series-connection way, the series-connection design can compact the structure of the USB connector device for an antenna in accordance with the present invention and reduce redundant cables, and it occupies a single one USB slot of the computer L only. The USB connector device is very useful and convenient in use.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A USB connector device for an antenna comprising:
a first cable having
an antenna end capable of being securely mounted on and electrically connected to the antenna; and
a receiver end opposite to the antenna end;
a receiver securely mounted on and electrically connected to the receiver end of the first cable;
a second cable having
a receiver end securely mounted on and electrically connected to the receiver; and
a USB (universal serial bus) end opposite to the receiver end of the second cable; and
a USB connector securely mounted on and electrically connected to the USB end of the second cable and having
a plug formed on and protruding out from the USB connector and capable of being inserted into a USB slot of a computer.

2. The USB connector device for an antenna as claimed in claim 1, wherein the USB connector has a receptacle formed in the USB connector and opposite to the plug.
